(19) United States
(12) Patent Application Publication
(10) Pub. No.: US 2025/0044111 A1
(43) Pub. Date: Feb. 6, 2025

(54) INFORMATION PROCESSOR AND METHOD FOR PROCESSING INFORMATION

(71) Applicants: TOYOTA JIDOSHA KABUSHIKI KAISHA, Aichi-ken (JP); NOMURA RESEARCH INSTITUTE, LTD., Tokyo (JP)

(72) Inventors: Kazuya NISHIMURA, Anjo-shi (JP); Naoki UENOYAMA, Kasugai-shi (JP); Keiko NAKANO, Kawasaki-shi (JP); Yohei NAKANISHI, Nagoya-shi (JP); Takahiro MATSUMURA, Tokyo (JP)

(21) Appl. No.: 18/786,574

(22) Filed: Jul. 29, 2024

(30) Foreign Application Priority Data
Aug. 1, 2023 (JP) 2023-125426

(51) Int. Cl. G01C 21/36; G06Q 50/40; G06V 20/54; G06V 20/62

(52) U.S. Cl. CPC G01C 21/3602; G01C 21/3685; G01C 21/3691; G06Q 50/40; G06V 20/54; G06V 20/625; G06V 2201/08

(57) ABSTRACT

A communication device receives image data sets from vehicles traveling along roads. Processing circuitry acquires image data sets that include images of vehicles. The processing circuit determines whether each vehicle in the images is a local vehicle or a tourist vehicle. Based on the determination, the processing circuitry calculates a first ratio for each road. The first ratio is the ratio of tourist vehicles in the vehicles on the road. The processing circuitry presents a tourist with a road of which the first ratio is greater than or equal to a first threshold value as a recommended road.

### CROSS-REFERENCE TO RELATED APPLICATIONS

This application is based upon and claims the benefit of priority from prior Japanese Patent Application No. 2023-125426, filed on Aug. 1, 2023, the entire contents of which are incorporated herein by reference.

### BACKGROUND

### 1. Field

The following description relates to an information processor and a method for processing information.

### 2. Description of Related Art

Japanese Laid-Open Patent Publication No. 07-332997 describes a vehicle that includes a GPS device and a data processor. Road information and tourist information for tourist sites are stored in advance in the data processor. The data processor uses the GPS device to detect the present position of the vehicle.

The data processor refers to the present position of the vehicle to acquire road information and tourist information for the area around the present position from a database. The data processor provides the driver of the vehicle with the acquired road information and tourist information.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an information processor includes a memory, a communication device, and processing circuitry. The memory is configured to store road information related to roads in a specific area. The specific area includes a tourist site and an area around the tourist site. The communication device is configured to receive image data sets from vehicles located in the specific area. The image data sets are data sets of images captured by cameras mounted on the vehicles. The image data sets are sent from the vehicles traveling along the roads in the specific area and received by the communication device. The processing circuitry is configured to execute acquiring ones of the image data sets including image of vehicles. The processing circuitry is configured to execute analyzing the images of the vehicles in the acquired ones of the image data sets to determine whether each of the vehicles in the images is a local vehicle driven by a local resident or a tourist vehicle driven by a tourist. Based on the determination of each of the vehicles in the images, the processing circuitry is also configured to execute calculating a first ratio for each of the roads. The first ratio being a ratio of one or more tourist vehicles in the vehicles on each of the roads. Further, the processing circuitry is configured to execute presenting, from the roads, a tourist with a road of which the first ratio is greater than or equal to a first threshold value as a recommended road to guide the tourist to use the road.

In a further general aspect, a method for processing information includes processes that are the same as the processes executed by the information processor.

In general, as the first ratio of a road increases, the road will be more accessible to a tourist. Thus, when the first ratio of a road is greater than or equal to the first threshold value and thereby accessible to a tourist, the road can be presented to a tourist as a recommended road to guide the tourist to use the road.

In general, the area around a tourist site includes facilities such as roads that are accessible to tourists who are visiting the tourist site and facilities such as roads that are accessible to local residents of a tourist area. Thus, for example, an autonomous organization that oversees the tourist site will attempt to implement measures to guide tourists, who are from another region and visiting the tourist site with a vehicle, to accessible facilities, such as roads. The above-described configuration allows such measures to be implemented.

Other features and aspects will be apparent from the following detailed description, the drawings, and the claims.

### BRIEF DESCRIPTION OF THE DRAWINGS

FIG. 1 shows one example of an information processing system.

FIG. 2 is a diagram illustrating information related to a specific area collected by the information processing system of FIG. 1.

FIG. 3 is a sequential diagram illustrating a collection control executed by the information processing system of FIG. 1.

FIG. 4 is a flowchart illustrating an update control executed by the information processing system of FIG. 1.

FIG. 5 is a sequence diagram illustrating a distribution control executed by the information processing system of FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Configuration of Information Processing System

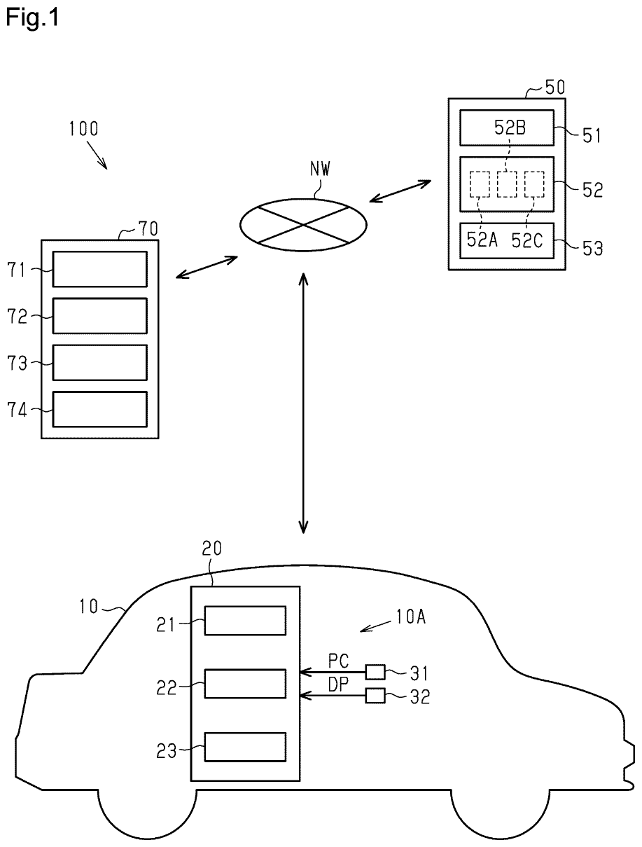

A system and method for processing information will now be described with reference to FIGS. 1 to 5. The configuration of an information processing system 100 will first be briefly described.

As shown in FIG. 1, the information processing system 100 includes one or more vehicles 10, a server 50, and one or more personal terminals 70. Each vehicle 10 is, for example, an automobile driven by a user. FIG. 1 shows only one of the vehicles 10.

Each vehicle 10 includes a driving recorder 10A. The driving recorder 10A is a device that records images or the like of the surrounding of the vehicle 10. The driving recorder 10A includes a Global Navigation Satellite System (GNSS) receiver 31 and a camera 32. The camera 32 is mounted on the vehicle 10.

The GNSS receiver 31 communicates with a GNSS satellite (not shown) to obtain position coordinates PC, which is the coordinates of the position where the vehicle 10 is located.

The camera 32 generates image data sets DP, which are data sets of captured images. In the present embodiment, the camera 32 generates image data sets DP of images captured in front of the vehicle 10. More specifically, the camera 32 captures images of other vehicles 10 located frontward from the vehicle 10 on which the camera 32 is mounted and generates the image data sets DP of the captured images.

The driving recorder 10A includes a vehicle controller 20. The vehicle controller 20 acquires a signal from the GNSS receiver 31 indicating the position coordinates PC of where the vehicle 10 is located. Further, the vehicle controller 20 acquires the image data sets DP of the camera 32.

The vehicle controller 20 includes a vehicle processing device 21, a vehicle storage device 22, and a vehicle communication device 23. The vehicle communication device 23 is configured to communicate with devices outside the vehicle 10 through a communication network NW. The vehicle storage device 22 includes a read-only memory (ROM) that only allows data to be read, a random-access memory (RAM) that is a volatile memory allowing data to be read and written, and a non-volatile storage allowing data to be read and written. The vehicle storage device 22 is a memory that stores information or the like acquired by the vehicle controller 20. The vehicle storage device 22 stores various programs in advance. One example of the vehicle processing device 21 is a central processing unit (CPU). The vehicle processing device 21 is processing circuitry that reads programs from the vehicle storage device 22 to execute various processes.

As shown in FIG. 1, the information processing system 100 includes the server 50. In the present embodiment, the server 50 is managed by an autonomous organization overseeing tourist site AT, which will be described later. The server 50 includes a server processing device 51, a server storage device 52, and a server communication device 53. The server communication device 53 is configured to communicate with devices outside the server 50 through the communication network NW. The server storage device 52 includes a ROM, a RAM, and storage. The server storage device 52 is a memory that stores information or the like acquired by the server 50. The server storage device 52 stores various programs and various data in advance. The server storage device 52 stores an information processing program 52A as one of the various programs. Further, the server storage device 52 stores map data 52B and web data 52C as the various data. The web data 52C relates to a website of the autonomous organization overseeing the tourist site AT. The map data 52B will be described later. One example of the server processing device 51 is a CPU. The server processing device 51 is processing circuitry that reads the information processing program 52A from the server storage device 52 to execute various processes. The server 50 is one example of an information processor.

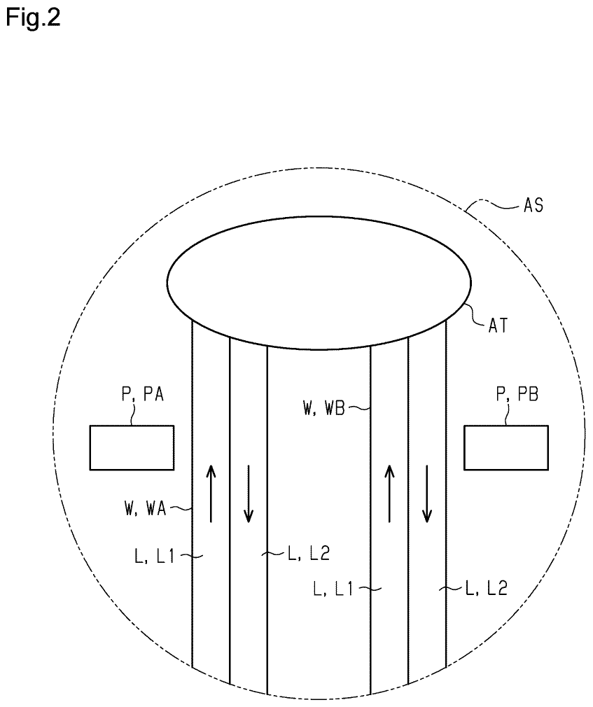

As shown in FIG. 2, the map data 52B is data of a map related to a specific area AS. The specific area AS is a predetermined area including the tourist site AT and the area around the tourist site AT. For example, the specific area AS includes one tourist site AT, two roads W, and two parking facilities P. In this specification, the two roads W will simply be referred to as the roads W when collectively described. When distinguishing the two roads W from each other, one will be referred to as the first road WA, and the other will be referred to as the second road WB. The two parking facilities P will simply be referred to as the parking facilities P when collectively described. When distinguishing the two parking facilities P from each other, one will be referred to as the first parking facility PA, and the other one will be referred to as the second parking facility PB. In the present embodiment, each road W includes one end connected to the tourist site AT. Further, each road W includes two lanes L, namely, a first lane L1 and a second lane L2. In the present embodiment, the first lane L1 is the lane L extending toward the tourist site AT. Further, the second lane L2 is the lane L extending away from the tourist site AT. In other words, in each road W, the first lane L1 is the lane L extending in a first direction. Further, in each road W, the second lane L2 is the lane L extending in a second direction. The second direction is opposite the first direction. That is, the first direction extends toward the tourist site AT, and the second direction extends away from the tourist site AT. FIG. 2 shows an example in which the vehicles 10 travel on the left-hand side, that is, along the left lane. The first parking facility PA is adjacent to the first road WA. The second parking facility PB is adjacent to the second road WB. The server storage device 52 stores road information on the roads W (WA, WB) in the specific area AS. The server storage device 52 also stores parking facility information related to the parking facilities P (PA, PB) in the specific area AS.

As shown in FIG. 1, the information processing system 100 includes one or more personal terminals 70. Examples of the personal terminals 70 are smartphones owned by users of the vehicles 10. FIG. 1 shows only one personal terminal 70.

Each personal terminal 70 includes a terminal processing device 71, a terminal storage device 72, a terminal communication device 73, and a terminal display 74. The terminal communication device 73 is configured to communicate with a device outside the personal terminal 70 through the communication network NW. The terminal storage device 72 includes a ROM, a RAM, and storage. The terminal storage device 72 is a memory that stores information or the like acquired by the personal terminal 70. Further, the terminal storage device 72 stores various programs in advance. One example of the terminal processing device 71 is a CPU. The terminal processing device 71 is processing circuitry that reads programs from the terminal storage device 72 to execute various processes. The terminal display 74 is configured to display various information. The terminal display 74 is a touch panel display. This allows the user to input various information through the terminal display 74.

### Collection Control

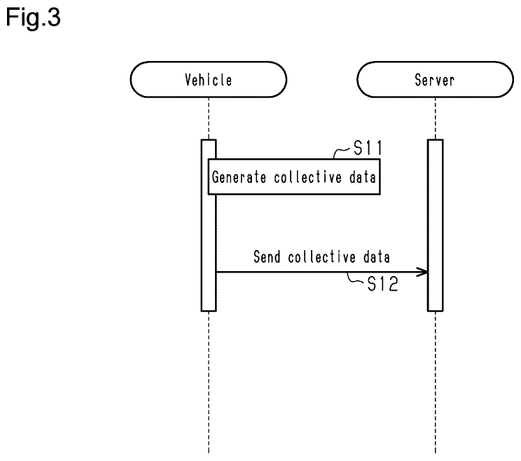

With reference to FIG. 3, collection control executed by the vehicle controller 20 and the server 50 will now be described. Collection control is executed by one server 50 and multiple vehicle controllers 20. The server 50 generates collective data DC, which will be described later, through the collection control. In the present embodiment, the vehicle controller 20 starts the collection control in predetermined control cycles. One example of the control cycle of the collection control is about several milliseconds to several seconds.

As shown in FIG. 3, when the collection control starts, the vehicle processing device 21 performs step S11. In step S11, the vehicle processing device 21 generates the collective data DC including the latest position coordinates PC and the image data set DP that are acquired by the vehicle controller 20 at the time step S11 is performed. More specifically, the vehicle processing device 21 generates the collective data DC by associating the position coordinates PC with the simultaneously acquired image data set DP. After step S11, the vehicle processing device 21 proceeds to step S12.

In step S12, the vehicle communication device 23 sends the collective data DC to the server 50.

The server communication device 53 receives the collective data DC from the vehicle controller 20. The server processing device 51 stores the collective data DC in the server storage device 52. After step S12, the server processing device 51 ends the collection control of the present cycle.

### Update Control

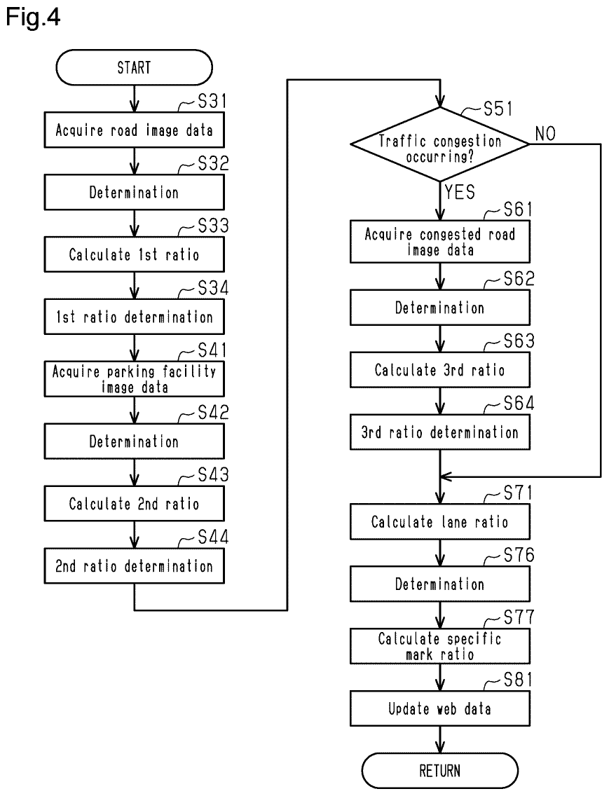

With reference to FIG. 4, update control executed by the server 50 will now be described. The update control updates the web data 52C. In the present embodiment, the server processing device 51 starts the update control in predetermined control cycles. One example of the control cycle of the update control is about several milliseconds to several seconds.

As shown in FIG. 4, when the update control starts, the server processing device 51 performs step S31. In step S31, the server processing device 51 acquires the image data sets DP that include images of the vehicles 10 in the image data sets DP sent from the vehicles 10 traveling along the roads W and received by the server communication device 53. More specifically, the server processing device 51 acquires the image data sets DP, for example, in the following manner. First, the server processing device 51 compares the position coordinates PC, which are associated with the image data sets DP, and the map data 52B. Then, the server processing device 51 extracts, from the image data sets DP stored in the server storage device 52, the image data sets DP sent from the vehicles 10 traveling along the roads W and received by the server communication device 53. Further, the server processing device 51 analyzes the image of each extracted image data set DP to determine whether the image includes a vehicle 10. For example, the server processing device 51 executes a known image analysis process to determine whether an image includes a vehicle 10. When the server processing device 51 determines that an image includes a vehicle 10, the server processing device 51 acquires the image data set DP of the image including the vehicle 10 in step S31. Then, the server processing device 51 proceeds to step S32.

In step S32, the server processing device 51 determines whether the vehicle 10 in the image of each image data set DP acquired in step S31 is a local vehicle driven by a local resident or a tourist vehicle driven by a tourist. More specifically, the server processing device 51 analyzes the image of the image data set DP and determines that the vehicle 10 is a tourist vehicle when finding at least one of tourist feature (1) and tourist feature (2), which are described below. When the server processing device 51 analyzes the image of the image data set DP and fails to find any of tourist feature (1) and tourist feature (2), the server processing device 51 determines that the vehicle 10 is a local vehicle. When the image of the image data set DP acquired in step S31 includes multiple vehicles 10, the server processing device 51 makes the above determination for each vehicle 10 in the image of the image data set DP in step S32.

Tourist feature (1) is that the place of registration shown on the license plate of the vehicle 10 in the image of the image data set DP differs from the place of registration shown on license plates issued in the specific area AS.

Tourist feature (2) is that a character shown on the license plate of the vehicle 10 in the image of the image data sets DP indicates that the vehicle 10 is a rental vehicle.

In one example, the specific area AS is located in Toyota City, Aichi Prefecture, Japan. In this case, the place of registration for the specific area AS is Toyota. Further, the Japanese hiragana character used for a rental vehicle is “ [symbol] ” or “ [symbol] ”. If the place of registration shown on the license plate of the vehicle 10 in the image of the image data set DP is not Toyota, the server processing device 51 determines that the vehicle 10 has feature (1). Further, if the Japanese hiragana character shown on the license plate of the vehicle 10 in the image of the image data set DP is “ [symbol] ” or “ [symbol] ” indicating that the vehicle 10 is a rental vehicle, the server processing device 51 determines that the vehicle 10 has tourist feature (2). After step S32, the server processing device 51 process to step S33.

In step S33, the server processing device 51 calculates a first ratio R1 based on the determination of step S32, that is, based on the determination made for each vehicle 10 in the image of each image data set DP. The first ratio R1 is a ratio of tourist vehicles driven by tourists in the vehicles 10 on a road W during a specific period from when step S33 is performed. The specific period in step S33 is, for example, more than ten days to about one month. The server processing device 51 calculates the first ratio R1 for each road W in the specific area AS. The first ratio R1 for each road W is expressed by Equation (1).

$$first ratio R 1 = ( total number of vehicles 10 on subject road W determined \\ as being tourist vehicles driven by tourists in step S 32 ) / \\ ( total number of vehicles 10 in image data sets \\ DP acquired in step S 31 for subject road W ) \times 100 \qquad Equation ( 1 )$$

After step S33, the server processing device 51 proceeds to step S34.

In step S34, the server processing device 51 determines whether the first ratio R1 is greater than or equal to a predetermined first threshold value RT1 for each road W in the specific area AS. The first threshold value RT1 is a threshold value for determining whether many tourist vehicles are being driven by tourists along a subject road W. The first threshold value RT1 for each road W is determined in advance through experiments, simulations, and/or the like. The first threshold value RT1 is, for example, greater than or equal to 20%. After step S34, the server processing device 51 proceeds to step S41.

In step S41, the server processing device 51 acquires the image data sets DP including images of vehicles 10 from the image data sets DP that are sent from parked vehicles located in the parking facilities P and received by the server communication device 53. More specifically, the server processing device 51 acquires the image data sets DP, for example, in the following manner. The server processing device 51 compares the position coordinates PC, which are associated with the image data sets DP, with the map data 52B, and extracts, from the image data sets DP stored in the server storage device 52, the image data sets DP sent from the parked vehicles located in the parking facilities P and received by the server communication device 53. Further, the server processing device 51 analyzes the image of each extracted image data set DP to determine whether the image includes a vehicle 10. When the server processing device 51 determines that an image includes a vehicle 10, the server processing device 51 acquires the image data set DP of the image. After step S41, the server processing device 51 proceeds to step S42.

In step S42, the server processing device 51 determines whether the vehicle 10 in the image of each image data set DP acquired in step S41 is a local vehicle driven by a local resident or a tourist vehicle driven by a tourist. Step S42 is similar to step S32. After step S42, the server processing device 51 proceeds to step S43.

In step S43, the server processing device 51 calculates a second ratio R2 based on the determination of step S42, that is, based on the determination made for each vehicle 10 in the image of each image data set DP. The second ratio R2 is a ratio of tourist vehicles, which are driven by tourists, in the parked vehicles 10 located in the parking facility P during a specific period from when step S43 is performed. The specific period in step S43 is, for example, more than ten days to about one month. The server processing device 51 calculates the second ratio R2 for each parking facility P in the specific area AS. The second ratio R2 for each parking facility P is expressed by Equation (2).

$$second ratio R 2 = ( total number of vehicles 10 in subject parking \\ facility P determined as being tourist \\ vehicles driven by tourists in step S 42 ) / \\ ( total number of vehicles 10 in images of image data sets \\ DP acquired in step S 41 for subject parking facility P ) \times 100. \qquad Equation ( 2 )$$

After step S43, the server processing device 51 proceeds to step S44.

In step S44, the server processing device 51 determines whether the second ratio R2 is greater than or equal to a predetermined second threshold value RT2 for each parking facility P in the specific area AS. The second threshold value RT2 is a threshold value for determining whether many tourist vehicles driven by tourists are parked in a subject parking facility P. The second threshold value RT2 for each road W is determined in advance through experiments, simulations, and/or the like. The second threshold value RT2 is, for example, greater than or equal to 20%. After step S44, the server processing device 51 proceeds to step S51.

In step S51, the server processing device 51 determines, for each road W in the specific area AS, whether traffic congestion is occurring. For example, the server processing device 51 determines whether traffic congestion is occurring on a road W based on changes in the position coordinates PC that are sent from the vehicles 10 traveling along the road W and received by the server communication device 53. In one example, the server processing device 51 determines that traffic congestion is occurring on a road W if the average moved distance obtained from changes in the position coordinates PC during a fixed period from when step S51 is performed is less than or equal to a specified moved distance. The fixed period is, for example, a few minutes to about an hour. When the server processing device 51 determines in step S51 that there is no traffic congestion on any of the roads W in the specific area AS (S51: NO), the server processing device 51 proceeds to step S71, which will be described later. When the server processing device 51 determines in step S51 that there is traffic congestion on at least one of the roads W in the specific area AS (S51: YES), the server processing device 51 proceeds to step S61.

In step S61, when traffic congestion is occurring on a road W, from the image data sets DP sent from the vehicles 10 caught in the traffic congestion and received by the server communication device 53, the server processing device 51 acquires the image data sets DP including images of vehicles 10. More specifically, the server processing device 51 acquires the image data sets DP, for example, in the following manner. The server processing device 51 finds the position coordinates PC, which are associated with the image data sets DP, corresponding to the roads W determined as being congested in step S51 to extract, from the image data sets DP stored in the server storage device 52, the image data sets DP that are sent from the vehicles 10 caught in the traffic congestion and received by the server communication device 53. Further, the server processing device 51 analyzes the image of each extracted image data set DP to determine whether the image includes a vehicle 10. When the server processing device 51 determines that an image includes a vehicle 10, the server processing device 51 acquires the image data set DP of the image. After step S61, the server processing device 51 proceeds to step S62.

In step S62, the server processing device 51 determines whether the vehicle 10 in the image of each image data set DP acquired in step S61 is a local vehicle driven by a local resident or a tourist vehicle driven by a tourist. Step S62 is similar to step S32. After step S62, the server processing device 51 proceeds to step S63.

In step S63, the server processing device 51 calculates a third ratio R3 based on the determination of step S62, that is, based on the determination made for each vehicle 10 in the image of each image data set DP. The third ratio R3 is a ratio of vehicles driven by tourists in the vehicles 10 caught in the traffic congestion during a predetermined reference period from when step S63 is performed. The reference period of step S63 is, for example, a few minutes to about an hour. The reference period of step S63 is shorter than the specified period of step S33. Thus, the third ratio R3 reflects a situation closer to the time when step S63 was performed than a case where the reference period of step S63 is the same as the specified period of step S33. The server processing device 51 calculates the third ratio R3 for each road W where traffic congestion is occurring. The third ratio R3 for each road W is expressed by Equation (3).

$$third ratio R 3 = ( total number of vehicles 10 on subject road W determined \\ as being tourist vehicles driven by tourists in step S 62 ) / \\ ( total number of vehicles 10 in images of image \\ data sets DP acquired in step S 61 for subject road W ) \times 100. \qquad Equation ( 3 )$$

After step S63, the server processing device 51 proceeds to step S64.

In step S64, the server processing device 51 determines whether the calculated third ratio R3 is greater than or equal to a predetermined third threshold value RT3 for each road W where traffic congestion is occurring. The third threshold value RT3 is a threshold value for determining whether many vehicles are being driven by tourists on a subject road W. The third threshold value RT3 for each road W is determined in advance through experiments, simulations, and/or the like. The third threshold value RT3 is, for example, greater than or equal to 20%. After step S64, the server processing device 51 proceeds to step S71.

In step S71, the server processing device 51 calculates a first lane ratio LR1 based on the determination of step S32, that is, based on the determination made for each vehicle 10 in the image of each image data set DP. The first lane ratio LR1 is a ratio of tourist vehicles driven by tourists in the vehicles 10 on the first lane L1 of a road W during a reference period from when step S71 is performed. Further, the server processing device 51 calculates a second lane ratio LR2 based on the determination of step S32, that is, based on the determination made for each vehicle 10 in the image of each image data set DP. The second lane ratio LR2 is a ratio of tourist vehicles driven by tourists in the vehicles 10 on the second lane L2 of a road W during the reference period from when step S71 is performed. In the present embodiment, the reference period of step S71 is, for example, a few minutes to about an hour. The reference period of step S71 is shorter than the specified period of step S33. Thus, the first lane ratio LR1 and the second lane ratio LR2 reflect a situation closer to the time when step S71 was performed than a case where the reference period of step S71 is the same as the specified period of step S33. The server processing device 51 calculates the first lane ratio LR1 and the second lane ratio LR2 for each road W in the specific area AS. After step S71, the server processing device 51 proceeds to step S76.

In step S76, the server processing device 51 analyzes the image of each image data set DP to determine whether a predetermined specific mark is applied to each vehicle 10 determined as being a tourist vehicle in step S32. The specific mark is a predetermined mark for identifying an occupant of a vehicle 10 and is applicable to the vehicle 10. One example of a specific mark is a novice driver mark. After step S76, the server processing device 51 proceeds to step S77.

In step S77, the server processing device 51 calculates a specific mark ratio SR based on the determination of step S76, that is, based on the determination made for each vehicle 10 in the image of each image data set DP. The specific mark ratio SR is a ratio of the vehicles 10 to which the specific mark is applied in the vehicles 10 determined as being tourist vehicles in step S32 during a specific period from when step S76 is performed. The specific period in step S77 is, for example, more than ten days to about one month. The server processing device 51 calculates the specific mark ratio SR for each road W in the specific area AS. The specific mark ratio SR for each road W is expressed by Equation (4).

$$specific mark ratio SR = ( total number of vehicles 10 on subject road W determined as having specific mark applied in step S 76 ) / ( total number of vehicles 10 determined as being tourist vehicles in step S 32 for subject road W ) \times 100. \qquad Equation ( 4 )$$

After step S77, the server processing device 51 proceeds to step S81.

In step S81, the server processing device 51 updates the web data 52C based on the determination of step S34, the determination of step S44, the determination of step S64, and the calculation of step S71. In this case, the web data 52C includes a website that posts a map of the specific area AS shown in FIG. 2. In one example, the server processing device 51 determines in step S34 that the first ratio R1 of the first road WA is greater than or equal to the first threshold value RT1. In this case, in step S81, the server processing device 51 updates the web data 52C so that the first road WA is indicated as “recommended for tourists” in the map of the specific area AS posted on the website. In other words, from the multiple roads W, the server processing device 51 presents a tourist with a road W of which the first ratio R1 is greater than or equal to the first threshold value RT1 as a recommended road to guide the tourist to use the road W. In one example, the server processing device 51 determines in step S44 that the second ratio R2 of the first parking facility PA is greater than or equal to the second threshold value RT2. In this case, in step S81, the server processing device 51 updates the web data 52C so that the first parking facility PA is indicated as “recommended for tourists” in the map of the specific area AS. In other words, from the multiple parking facilities P, the server processing device 51 presents a parking facility P of which the second ratio R2 is greater than or equal to the second threshold value RT2 as a recommended parking facility to guide a tourist to use the parking facility. In one example, the server processing device 51 determines in step S64 that the third ratio R3 of the first road WA is greater than or equal to the third threshold value RT3. In this case, in step S81, the server processing device 51 updates the web data 52C so that the first road WA is indicated as “traffic congestion due to many tourists visiting tourist site AT” in the map of the specific area AS posted on the website. In other words, when the third ratio R3 of a road W is greater than or equal to the third threshold value RT3, the server processing device 51 notifies tourists that traffic congestion is occurring due to tourists visiting the tourist site AT. In step S81, the server processing device 51 updates the web data 52C so that the first lane ratio LR1 calculated in step S71 is added to the first lane L1 of the first road WA in the map of the specific area AS posted on the website. Further, the server processing device 51 updates the web data 52C so that the second lane ratio LR2 calculated in step S71 is added to the second lane L2 of the first road WA in the map of the specific area AS posted on the website. In other words, the server processing device 51 notifies tourists of the first lane ratio LR1 and the second lane ratio LR2. After step S81, the server processing device 51 ends the present cycle of the update control.

### Distribution Control

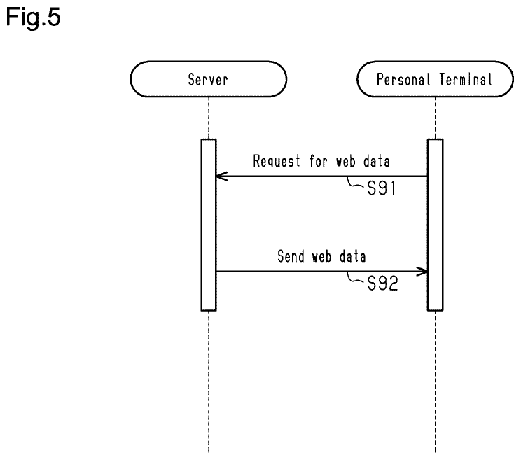

With reference to FIG. 5, distribution control executed by the server 50 and the personal terminals 70 will now be described. The distribution control is executed between the single server 50 and the multiple personal terminals 70. The distribution control is executed to send the web data 52C from the server 50 to the personal terminals 70. In the present embodiment, the distribution control is started each time a user requests for distribution of the web data 52C through the terminal display 74 of a personal terminal 70. For example, the user requests for distribution of the web data 52C by using a web browser to access the website of the autonomous organization managing the tourist site AT.

As shown in FIG. 5, the terminal processing device 71 performs step S91 when starting the distribution control. In step S91, the terminal communication device 73 sends a signal to the server 50 requesting for transmission of the web data 52C.

The server communication device 53 receives the web data transmission request signal from the personal terminal 70. After step S91, the server processing device 51 proceeds to step S92.

In step S92, the server communication device 53 transmits the web data 52C to the personal terminal 70.

The terminal communication device 73 receives the web data 52C from the server 50. The terminal processing device 71 shows the map of the specific area AS, which is based on the web data 52C, on the terminal display 74. After step S92, the terminal processing device 71 ends the present cycle of the distribution control.

### Operation of Present Embodiment

As shown in FIG. 4, in steps S31 to S33, the server processing device 51 calculates the first ratio R1, which is the ratio of tourist vehicles driven by tourists in the vehicles 10 on a road W. Then, in step S34, the server processing device 51 determines whether the first ratio R1 is greater than or equal to the first threshold value RT1 for each road W in the specific area AS. When the first ratio R1 of a road W is greater than or equal to the first threshold value RT1, it can be inferred that the road W is easy to use for a tourist who is driving the vehicle 10 to and away from the tourist site AT. In one example, the server processing device 51 determines in step S34 that the first ratio R1 of the first road WA is greater than or equal to the first threshold value RT1. In this case, in step S81, the server processing device 51 updates the web data 52C so that the first road WA is indicated as “recommended for tourists” in the map of the specific area AS posted on the website. In other words, from the multiple roads W, the server processing device 51 presents a tourist with a road W of which the first ratio R1 is greater than or equal to the first threshold value RT1 as a recommended road to guide the tourist to use the road W.

### Advantages of Present Embodiment

(1) In general, as the first ratio R1 of a road W increases, the road W will be more accessible to a tourist. Thus, in the present embodiment, when the first ratio R1 of a road W is greater than or equal to the first threshold value RT1, the road W is presented to a tourist as a recommended road to guide the tourist to use the road W.

(2) In steps S41 to S43, the server processing device 51 calculates the second ratio R2, which is the ratio of vehicles driven by tourists in the vehicles 10 located in a parking facility P. Then, in step S44, the server processing device 51 determines whether the second ratio R2 is greater than or equal to the second threshold value RT2 for each parking facility P in the specific area AS. When the second ratio R2 of a parking facility P is greater than or equal to the second threshold value RT2, it can be inferred that the parking facility P is convenient for tourists parking their vehicles 10. In one example, the server processing device 51 determines in step S44 that the second ratio R2 of the first parking facility PA is greater than or equal to the second threshold value RT2. In this case, in step S81, the server processing device 51 updates the web data 52C so that the first parking facility PA is indicated as “recommended for tourists” in the map of the specific area AS. In other words, from the multiple parking facilities P, the server processing device 51 presents a parking facility P of which the second ratio R2 is greater than or equal to the second threshold value RT2 as a recommended parking facility to guide a tourist to use the parking facility. In general, as the second ratio R2 of a parking facility P increases, the parking facility P will be more accessible to a tourist. Thus, in the present embodiment, when the second ratio R2 of a parking facility P is greater than or equal to the second threshold value RT2, the parking facility P is presented to a tourist as a recommended parking facility to guide the tourist to use the parking facility P.

(3) In steps S51 to S63, the server processing device 51 calculates the third ratio R3, which is the ratio of vehicles driven by tourists in the vehicles 10 caught in traffic congestion. Then, in step S64, the server processing device 51 determines whether the third ratio R3 is greater than or equal to the predetermined third threshold value RT3 for each road W where traffic congestion is occurring. In one example, the server processing device 51 determines in step S64 that the third ratio R3 of the first road WA is greater than or equal to the third threshold value RT3. In this case, in step S81, the server processing device 51 updates the web data 52C so that the first road WA is indicated as “traffic congestion due to many tourists visiting tourist site AT” in the map of the specific area AS posted on the website. In other words, when the third ratio R3 of a road W is greater than or equal to the third threshold value RT3, the server processing device 51 notifies tourists that traffic congestion is occurring due to tourists visiting the tourist site AT.

For example, when tourist vehicles, which are driven by tourists cause traffic congestion on a road W, the traffic congestion will most likely be a temporary one and shorter than traffic congestion caused by local vehicles, which are driven by local residents. In the present embodiment, a tourist will be notified of the roads W where traffic congestion is occurring due to many tourists visiting the tourist site SA. This allows the tourist to adjust sightseeing schedules taking into consideration traffic congestion that is likely to be occurring temporarily. For example, a tourist may stay at the tourist site AT for a longer time to avoid traffic congestion occurring on the roads W.

(4) In step S71, the server processing device 51 calculates the first lane ratio LR1, which is the ratio of vehicles driven by tourists in the vehicles 10 on the first lane L1 of a road W. Further, the server processing device 51 calculates the second lane ratio LR2, which is the ratio of vehicles driven by tourists in the vehicles 10 on the second lane L2 of a road W. In step S81, the server processing device 51 updates the web data 52C so that the first lane ratio LR1 calculated in step S71 is added to the first lane L1 of the first road WA in the map of the specific area AS posted on the website. Further, the server processing device 51 updates the web data 52C so that the second lane ratio LR2 calculated in step S71 is added to the second lane L2 of the first road WA in the map of the specific area AS posted on the website. In other words, the server processing device 51 notifies tourists of the first lane ratio LR1 and the second lane ratio LR2.

In the present embodiment, the first lane L1 is the lane L extending toward the tourist site AT. Further, the second lane L2 is the lane L extending away from the tourist site AT. Thus, as the first lane ratio LR1 increases and becomes greater than the second lane ratio LR2, more tourists will be visiting the tourist site AT. The present embodiment allows a tourist to check whether the number of tourists visiting the tourist site AT is increasing or decreasing by referring to the first lane ratio LR1 and the second lane ratio LR2.

(5) In steps S76 and S77, the server processing device 51 calculates the specific mark ratio SR, which is the ratio of the vehicles 10 to which the specific mark is applied in the vehicles 10 determined as being tourist vehicles. Thus, for example, the autonomous organization managing the server 50 can check the ratio of the vehicles 10 to which the specific mark is applied in the vehicles 10 determined as being tourist vehicles. That is, in the vehicles 10 determined as being tourist vehicles, the autonomous organization can check the ratio of tourist vehicles that are driven by tourists who are not used to driving and have novice driver marks applied to their vehicles. When the autonomous organization managing the server 50 knows the ratio of tourists who have specific marks applied to their vehicles 10, the autonomous organization can improve facilities in accordance with such tourists.

### MODIFIED EXAMPLES

The above embodiment may be modified as described below. The above embodiment and the modified examples described below may be combined as long as there is no technical contradiction.

In the above embodiment, changes may be made to the update control.

For example, the features used for determination in step S32 may be changed. More specifically, both of tourist feature (1) and tourist feature (2) do not have to be used in step S32. For example, only tourist feature (1) may be used. In the same manner, the features used for the determination in step S42 may be changed. Further, the features used for determination in step S42 may differ from the features used for determination in step S32. The features used for determination in step S62 may also be changed in the same manner.

For example, steps S41 to S44 may be omitted. Steps S41 to S44 may be omitted as long as the necessity is low for providing a tourist with a recommended parking facility.

For example, the determination of the occurrence of traffic congestion on the roads W may be performed in a manner that differs from step S51. More specifically, the server processing device 51 may acquire information from outside the server 50 through a traffic information system to determine whether traffic congestion is occurring on the roads W.

For example, steps S61 to S64 may be omitted. More specifically, steps S61 to S64 may be omitted as long as the necessity is low for notifying tourists that traffic congestion is occurring due to tourists visiting the tourist site AT.

For example, step S71 may be omitted. More specifically, step S71 may be omitted as long as the necessity is low for notifying tourists of the first lane ratio LR1 and the second lane ratio LR2.

For example, the specific mark in steps S76 and S77 may be changed. More specifically, the specific mark is not limited to a novice driver mark and may be a senior driver mark or a child-on-board mark.

For example, changes may be made to steps S76 and S77. The server processing device 51 may calculate the specific mark ratio SR as the ratio of the vehicles 10 to which the specific mark is applied in the vehicles 10 determined as being tourist vehicles in step S42.

For example, steps S76 and S77 may be omitted. More specifically, steps S76 and S77 may be omitted as long as the necessity is low for checking the ratio of tourist vehicles to which the specific mark is applied.

The vehicle processing device 21, the server processing device 51, and the terminal processing device 71 may each include a CPU and a ROM and be configured to process software. These processing devices are not limited to the configuration described above. More specifically, each processing device may have any of following configurations (a), (b), and (c).

(a) A processing device includes one or more processors that executes various processes in accordance with a computer program. Each processor includes a CPU and a memory, such as a RAM and a ROM. The memory stores, for example, program codes or instructions to have the CPU process the provided information. A memory, which is a non-transitory and computer-readable storage medium, includes any medium that is accessible by a versatile or dedicated computer.

(b) A processing device includes one of more dedicated hardware circuitry for execution of various processes. Examples of dedicated hardware circuitry include an Application Specific Integrated Circuit (ASIC) or a Field Programmable Gate Array (FPGA).

(c) A processing device includes a processor, which executes some of the processes, and dedicated hardware circuitry, which executes the remaining processes.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An information processor, comprising:
a memory;
a communication device; and
processing circuitry, wherein
the memory is configured to store road information related to roads in a specific area, the specific area including a tourist site and an area around the tourist site,
the communication device is configured to receive image data sets from vehicles located in the specific area, the image data sets are data sets of images captured by cameras mounted on the vehicles, and the image data sets are sent from the vehicles traveling along the roads in the specific area and received by the communication device,
the processing circuitry is configured to execute
acquiring ones of the image data sets including images of vehicles,
analyzing the images of the vehicles in the acquired ones of the image data sets to determine whether each of the vehicles in the images is a local vehicle driven by a local resident or a tourist vehicle driven by a tourist,
based on the determination of each of the vehicles in the images, calculating a first ratio for each of the roads, the first ratio being a ratio of one or more tourist vehicles in the vehicles on each of the roads, and
presenting, from the roads, a tourist with a road of which the first ratio is greater than or equal to a first threshold value as a recommended road to guide the tourist to use the road.

2. The information processor according to claim 1, wherein
the memory stores parking facility information related to parking facilities in the specific area,
the processing circuitry is configured to execute
acquiring ones of the image data sets including images of vehicles sent from the vehicles located in the parking facilities and received by the communication device,
analyzing the images of the vehicles in the acquired ones of the image data sets to determine whether each of the vehicles in the images is a local vehicle or a tourist vehicle,
based on the determination of each of the vehicles in the images, calculating a second ratio for each of the parking facilities, the second ratio being a ratio of one or more tourist vehicles in the vehicles located in each of the parking facilities, and
from the parking facilities, presenting the tourist with a parking facility of which the second ratio is greater than or equal to a second threshold value as a recommended parking facility to guide the tourist to use the parking facility.

3. The information processor according to claim 1, wherein the processing circuitry is configured to execute
when traffic congestion occurs in one of the roads, acquiring ones of image data sets including images of vehicles sent from the vehicles caught in the traffic congestion and received by the communication device,
analyzing the images of the vehicles in the acquired ones of the image data sets to determine whether each of the vehicles in the images is a local vehicle or a tourist vehicle, based on the determination of each of the vehicles in the images, calculating a third ratio of one or more tourist vehicles in the vehicles caught in the traffic congestion, and
when the calculated third ratio is greater than or equal to a third threshold value, notifying tourists that the traffic congestion is occurring on the one of the roads due to many tourists visiting the tourist site.

4. The information processor according to claim 1, wherein the processing circuitry is configured to execute
based on the determination of the analyzed image of the vehicles, calculating a first lane ratio of one or more tourist vehicles in vehicles traveling on the roads along a first lane extending in a first direction,
based on the determination of the analyzed image of the vehicles, calculating a second lane ratio of one or more tourist vehicles in vehicles traveling on the roads along a second lane extending in a second direction, and
notifying one or more tourists of the first lane ratio and the second lane ratio.

5. The information processor according to claim 1, wherein
a specific mark for identifying an occupant of a vehicle is applicable to each of the vehicles,
the processing circuitry is configured to further execute
acquiring ones of image data sets including images of vehicles sent from one or more vehicles located in the specific area and received by the communication device,
analyzing the images of the vehicles in the acquired ones of the image data sets to determine whether each of the vehicles in the images is a local vehicle or a tourist vehicle, and
calculating a specific mark ratio of vehicles to which the specific mark is applied in vehicles determined as being tourist vehicles.

6. A method for processing information, the method comprising:
storing road information in a memory of an information processor, wherein the road information is related to roads in a specific area, and the specific area includes a tourist site and an area around the tourist site;
receiving image data sets from vehicles located in the specific area with a communication device of the information processor, wherein the image data sets are data sets of images captured by cameras mounted on the vehicles, and the image data sets are sent from the vehicles traveling along the roads in the specific area and received by the communication device;
acquiring ones of the image data sets including images of vehicles with processing circuitry of the information processor;
analyzing the images of the vehicles in the acquired ones of the image data sets with the processing circuitry to determine whether the each of the vehicles is a local vehicle driven by a local resident or a tourist vehicle driven by a tourist;
based on the determination of each of the vehicles in the images, calculating a first ratio of one or more tourist vehicles in the vehicles on each of the roads with the processing circuitry; and
presenting, from the roads, a tourist with a road of which the first ratio is greater than or equal to a first threshold value as a recommended road to guide the tourist to use the road with the processing circuitry.
